(19) United States
(12) Patent Application Publication
(10) Pub. No.: US 2025/0243897 A1
(43) Pub. Date: Jul. 31, 2025

(54) METHOD FOR MANUFACTURING MOUNTING ASSEMBLY COMPRISING CONNECTING ROD AND TANG

(71) Applicant: SKF Aerospace France S.A.S, Perrigny (FR)

(72) Inventors: Florent Denis Fauchery, Montmeyran (FR); Florian Vincent BARDY, Perrigny (FR); Eric Jean-Marie DENEUX, Metz (FR)

(21) Appl. No.: 19/033,713

(22) Filed: Jan. 22, 2025

(30) Foreign Application Priority Data
Jan. 31, 2024 (FR) 2400942

(51) Int. Cl. F16C 11/04

(52) U.S. Cl. CPC F16C 11/045; F16C 2226/62

(57) ABSTRACT

A method for connecting a tang between a first arm and a second arm of a connecting rod includes inserting a cylindrical portion of a contact ring into a bore of the first arm until a bearing surface of the first flange contacts a first side of the first arm, deforming the second end of the cylindrical portion of the contact ring to form a second flange and to cause a bearing surface of the second flange to contact the second side of the first arm, inserting the tang axially between the first arm and the second arm, and inserting a mounting shaft through the bore of the first arm and a bore of the tang and a bore of the second arm so that a gap exists between the first arm and the tang.

### CROSS-REFERENCE

This application claims priority to French patent application no. 2400942 filed on Jan. 31, 2024, the contents of which are fully incorporated herein by reference.

### TECHNOLOGICAL FIELD

The present disclosure is directed to connecting rods and a method of mounting a connecting rod clevis. More specifically, the disclosure is directed to a mounting assembly that includes a mounting shaft, a connecting rod provided with two connecting portions (arms), and a tang, and to a method for manufacturing a mounting assembly that includes a mounting shaft, a connecting rod provided with two connecting portions, and a tang.

### BACKGROUND

An existing mounting assembly 1, as shown in FIG. 1, comprises a connecting rod clevis 2 provided with two connecting portions 3 and 4, which may comprise arms, and a tang 5, these being mounted on a mounting shaft 6 in order to fix the connecting rod 2 and the tang 5 around the mounting axis X. The two connecting portions 3 and 4 are generally made of a carbon-fiber-reinforced plastic, and the tang is made of metal, such as aluminum.

Conventionally, two contact rings 7 and 8 are also interposed radially between the mounting shaft 6 and the connecting portions 3 and 4. The proximity and contact that result from the mounting of the connecting rod 2 and of the tang 5 lead to the occurrence of galvanic corrosion at the interface between the connecting portions 3 and 4 and the tang 5. However, this phenomenon brings about premature wear of the mounting assembly 1.

In order to reduce or prevent such galvanic corrosion, it is known to provide a layer 9, 10 of glass-fiber-reinforced plastic material, generally in the form of a ply, on the surface of the connecting portions 3 and 4 that comes into contact with the tang 5. However, the addition of such a layer 9, 10 to the connecting portions of the connecting rod increases the weight of the mounting assembly 1. Given its nature and the steps for manufacturing it, the layer 9, 10 also makes it particularly expensive to obtain the mounting assembly 1. In addition, the presence of glass fibers in the layer 9, 10 makes it difficult or impossible to recycle the carbon fibers of the carbon-fiber-reinforced plastics material of the connecting portions 3 and 4 of the connecting rod 2 after the mounting assembly 1 has been scrapped.

### SUMMARY

An aspect of the disclosure is therefore to overcome these drawbacks and to provide a configuration of a mounting assembly comprising a mounting shaft, a connecting rod, and a tang that makes it possible to eliminate the occurrence of galvanic corrosion at the interface between the connecting rod and the tang.

The disclosure also provides a method for manufacturing a mounting assembly comprising first and second connecting portions of a connecting rod and a tang that are assembled around a mounting shaft. The method includes fitting a first contact ring in a bore in a first connecting portion of the connecting rod, the first contact ring comprising an axial portion and a first radial flange that extends from the axial portion towards the outside, the first radial flange of the first contact ring having a bearing surface that bears axially against a first face of the first connecting portion of the connecting rod and fitting a second contact ring in the bore in the second connecting portion of the connecting rod, the second contact ring comprising an axial portion and a first radial flange that extends from the axial portion towards the outside, the first radial flange of the second contact ring having a bearing surface that bears axially against a first face of the second connecting portion of the connecting rod. The method also includes forming a second radial flange that extends from the axial portion of the first contact ring towards the outside by deforming the axial portion, the second radial flange of the first contact ring having a bearing surface that bears axially against a second face of the first connecting portion of the connecting rod and forming a second radial flange that extends from the axial portion of the second contact ring towards the outside by deforming the axial portion, the second radial flange of the second contact ring having a bearing surface that bears axially against a second face of the second connecting portion of the connecting rod. The method further includes positioning the tang axially between the first and second connecting portions of the connecting rod, and fitting the tang and the first and second connecting portions of the connecting rod around the mounting shaft, the tang being positioned axially between the first and second connecting portions of the connecting rod. One of the first and second radial flanges of the first contact ring is provided with a contact surface that comes into axial contact with a first lateral face of the tang or is located next to the first lateral face, and forms a first axial space between the first connecting portion of the connecting rod and the first face of the tang. Also, one of the first and second radial flanges of the second contact ring is provided with a contact surface that comes into axial contact with a second lateral face of the tang or is located next to the second lateral face, and forms a second axial space between the second connecting portion of the connecting rod and the second lateral face of the tang.

In one embodiment, the outer surface of the axial portion of the first contact ring may contact the bore in the first connecting portion, and the outer surface of the axial portion of the second contact ring may contact the bore in the second connecting portion.

Advantageously, the axial portion of the first contact ring may comprise first and second axially opposite ends, the first radial flange of the first contact ring extending from the first end of the axial portion towards the outside, and the axial portion of the second contact ring may comprise first and second axially opposite ends, the first radial flange of the second contact ring extending from the first end of the axial portion towards the outside.

Advantageously, the axial portion of the first contact ring may comprise first and second axially opposite ends, the second radial flange extending from the second end of the axial portion, and the axial portion of the second contact ring may comprise first and second axially opposite ends, the second radial flange of the second contact ring extending from the second end of the axial portion.

In one embodiment, the axial portion of the first contact ring may comprises first and second axially opposite ends, the second end of the axial portion of the first contact ring being radially discontinuous, the second radial flange of the first contact ring formed by deformation of the second end having a plurality of radial lips, and the axial portion of the second contact ring may comprise first and second axially opposite ends, the second end of the axial portion of the second contact ring being radially discontinuous, the second radial flange of the second contact ring formed by deformation of the second end having a plurality of radial lips.

Advantageously, the manufacturing method may comprise forming a bevel on the periphery of the first radial flange of the first contact ring, the first radial flange of the first contact ring being positioned next to the tang, and forming a bevel on the periphery of the first radial flange of the second contact ring, the first radial flange of the second contact ring being positioned next to the tang.

According to one feature, the manufacturing method may comprise fitting the first and second connecting portions of the connecting rod comprising a carbon-fiber-reinforced thermoplastic or thermosetting matrix. According to one feature, the manufacturing method may comprise the fitting of the tang comprising a metallic material, such as aluminum or an aluminum alloy.

The disclosure also relates to a mounting assembly comprising a mounting shaft, a connecting rod provided with first and second connecting portions, and a tang, the first and second connecting portions of the connecting rod and the tang being positioned around the mounting shaft, the tang being disposed on the mounting shaft axially between the first and second connecting portions of the connecting rod, the contact assembly also comprising a first contact ring interposed radially between the bore in the first connecting portion of the connecting rod and the mounting shaft, the first contact ring comprising a first radial flange that extends from an axial portion of the first contact ring towards the outside and has a bearing surface that bears axially against a first face of the first connecting portion of the connecting rod, and has a contact surface that comes into axial contact with a first lateral face of the tang or is located next to the first lateral face, and a second radial flange that extends from the axial portion towards the outside and is provided with a bearing surface that comes into axial contact with a second face of the first connecting portion of the connecting rod, a second contact ring interposed radially between the bore in the second connecting portion of the connecting rod and the mounting shaft, the second contact ring comprising a first radial flange that extends from an axial portion of the second contact ring towards the outside and is provided with a bearing surface that bears axially against a first face of the first connecting portion of the connecting rod, and has a contact surface that comes into axial contact with a second lateral face of the tang or is located next to the second lateral face, and a second radial flange that extends from the axial portion towards the outside, being provided with a bearing surface that comes into axial contact with a second face of the second connecting portion of the connecting rod; and a first axial space between the first connecting portion of the connecting rod and the first face of the tang, and a second axial space between the second connecting portion of the connecting rod and the second face of the tang.

### BRIEF DESCRIPTION OF THE DRAWINGS

Further aims, advantages and features will become apparent from the following description, which is given purely by way of illustration and with reference to the appended drawings, in which:

FIG. 1 is a sectional elevational view of a conventional mounting assembly comprising a connecting rod and a tang.

FIG. 2 is a sectional elevational view of a mounting assembly comprising a connecting rod and a tang according to a first embodiment of the present disclosure.

FIG. 3 is a sectional elevational view of a mounting assembly comprising a connecting rod and a tang according to a second embodiment of the present disclosure.

FIG. 4 is a side elevational view of a mounting assembly according to an embodiment of the present disclosure.

FIG. 5 is a flow chart that illustrates a method for manufacturing a mounting assembly according to an embodiment of the present disclosure.

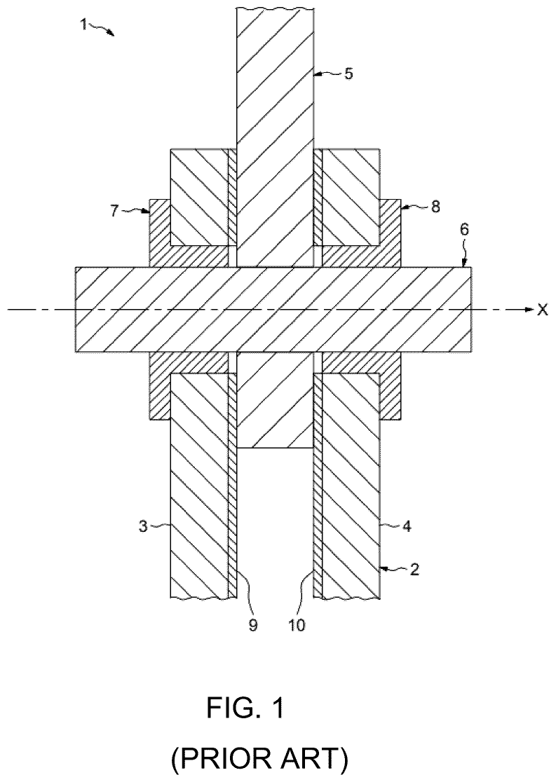

### DETAILED DESCRIPTION

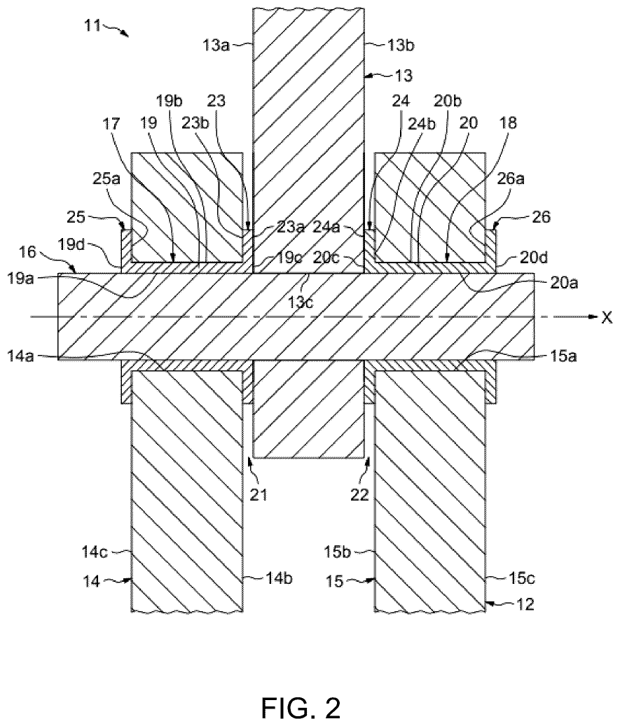

FIG. 2 illustrates a mounting assembly 11 according to a first embodiment of the disclosure. The mounting assembly comprises a connecting rod 12 and a tang 13. The connecting rod 12 comprises at least one forked end forming a connecting rod clevis and having first and second connecting portions 14 and 15, respectively, sometimes referred to hereinafter as first and second arms.

The first connecting portion 14 has a bore 14a, a first face 14b and a second face 14c facing axially away from the first face 14b. The thickness of the first connecting portion 14 is defined by the first and second faces 14b and 14c. Similarly, the second connecting portion 15 comprises a bore 15a, a first face 15b and a second face 15c facing axially away from the first face 15b. The thickness of the second connecting portion 15 is defined by the first and second faces 15b and 15c.

The first and second connecting portions 14 and 15 of the connecting rod 12 and the tang 13 are positioned around a common mounting shaft 16 of the assembly. The mounting shaft 16 extends from along an axis X. Moreover, the tang 13 is disposed on the mounting shaft 16 axially between the first and second connecting portions 14 and 15 of the connecting rod 12.

The tang 13 comprises a first lateral face 13a and a second lateral face 13b facing axially away from the first lateral face 13a of the tang 13. The first and second lateral faces 13a and 13b define the thickness of the tang 13. The tang 13 also comprises a bore 13c bearing against the outer surface of the mounting shaft 16.

The mounting assembly 11 also comprises first and second contact rings 17 and 18, respectively. The first contact ring 17 comprises an axial portion 19 having a bore 19a, an outer surface 19b facing radially away from the bore 19a, and first and second frontal faces 19c and 19d that face axially away from one another and define the axial length of the axial portion 19. Similarly, the second contact ring 18 comprises an axial portion 20 having a bore 20a, an outer surface 20b facing radially away from the bore 20a, and first and second frontal faces 20c and 20d that face axially away from one another and define the axial length of the axial portion 20.

The first contact ring 17 is interposed radially between the bore 14a in the first connecting portion 14 of the connecting rod 12 and the mounting shaft 16. Similarly, the second contact ring 18 is interposed radially between the bore 15a in the second connecting portion 15 of the connecting rod 12 and the mounting shaft 16.

In the example illustrated, the bore 19a in the axial portion 19 of the first contact ring 17 and the bore 20a in the axial portion 20 of the second contact ring 18 are positioned against the outer surface of the mounting shaft 16. In the example illustrated, the outer surface 19b of the axial portion 19 of the first contact ring 17 and the outer surface 20b of the axial portion 20 of the second contact ring 18 are positioned, respectively, against the bore 14a in the first connecting portion 14 and against the bore 15a in the second connecting portion 15.

The first contact ring 17 bears axially against the first lateral face 13a of the tang 13, and the second contact ring 18 bears axially against the second lateral face 13b of the tang 13. A first axial space 21 is provided between the first connecting portion 14 of the connecting rod 12 and the first face 13a of the tang 13 and a second axial space 22 is provided between the second connecting portion 15 of the connecting rod 12 and the second face 13b of the tang 13.

The first frontal face 19c of the axial portion 19 of the first contact ring 17 is positioned in contact with the first lateral face 13a of the tang 13 and the second frontal face 20c of the axial portion 20 of the second contact ring 18 is positioned in contact with the second lateral face 13b of the tang 13.

Furthermore, the first contact ring 17 comprises a first radial flange 23. The first radial flange 23 of the first contact ring 17 extends radially in the first axial space 21. In the example illustrated, the first radial flange 23 extends from a first axial end of the axial portion 19 towards the outside. The first radial flange 23 of the first contact ring 17 is, moreover, has a contact surface 23a that is in contact with the first lateral face 13a of the tang 13 and extends from the frontal face 19c of the axial portion 19 radially towards the outside.

Similarly, the second contact ring 18 comprises a first radial flange 24. The first radial flange 24 of the second contact ring 18 extends radially in the second radial space 22. In the example illustrated, the first radial flange 24 extends from a first axial end of the axial portion 20 towards the outside.

The first radial flange 24 of the second contact ring 18 is provided with a contact surface 24a that is in contact with the second lateral face 13b of the tang 13 and extends from the frontal face 20c of the axial portion 20 radially towards the outside.

In the example illustrated, the first radial flange 23 of the first contact ring 17 comprises a bearing surface 23b that faces axially away from the contact surface 23a and comes into axial contact with the first face 14b of the first connecting portion 14 which is disposed next to the first lateral face 13a of the tang 13. The first radial flange 23 of the first contact ring 17 extends from axially between the first face 14b of the first connecting portion 14 and the first lateral face 13a of the tang 13.

Similarly, the first radial flange 24 of the second contact ring 18 comprises a bearing surface 24b that faces axially away from the contact surface 24a and comes into axial contact with the first face 15b of the second connecting portion 15 which is disposed next to the second lateral face 13b of the tang 13. The first radial flange 24 of the second contact ring 18 extends from axially between the first face 15b of the second connecting portion 15 and the second lateral face 13b of the tang 13.

Furthermore, the first contact ring 17 may also comprise a second radial flange 25 which extends from the axial portion 19 towards the outside. In the example illustrated, the second radial flange 25 extends from a second axial end of the axial portion 19 that faces axially away from the first axial end. The second radial flange 25 of the second contact ring 17 has a bearing surface 25a that comes into contact with the second face 14c of the first connecting portion 14 of the connecting rod 12. The second contact ring 18 also comprises a second radial flange 26 which extends from the axial portion 20 towards the outside. In the example illustrated, the second radial flange 26 extends from a second axial end of the axial portion 20 that faces axially away from the first axial end. The second radial flange 26 of the second contact ring 18 has a bearing surface 26a that comes into contact with a second face 15c of the second connecting portion 15 of the connecting rod 12.

The first radial flanges 23, 24 of the first and second contact rings 17 and 18 bearing against the tang 13 keep the first and second connecting portions 14, 15 of the connecting rod 12 at a distance from the tang 13. Such a configuration of the mounting assembly makes it possible to eliminate, by way of a simple and inexpensive mechanism, the occurrence of galvanic corrosion associated with contacts between the connecting rod 12 and the tang 13.

Furthermore, the presence of the first and second axial spaces 21, 22 between the first and second connecting portions 14, 15 of the connecting rod 12 and the tang 13 eliminate the need to have a smooth surface on the first faces 14b, 15b of the first and second connecting portions 14, 15. The manufacture of the mounting assembly 11 does not require a step of finish-machining the first faces 14b and 15b of the first and second connecting portions 14, 15. Rough-cast first and second connecting portions 14, 15 can be used.

In the embodiment illustrated in FIG. 2, the frontal face 19c and the contact surface 23a of the first contact ring 17 are disposed in contact with the first lateral face 13a of the tang 13. Similarly, the frontal face 20c and the contact surface 24a of the second contact ring 18 are disposed in contact with the second lateral face 13b of the tang 13. However, in one embodiment variant, the frontal face 19c and the contact surface 23a of the first contact ring 17 may be disposed next to the first lateral face 13a of the tang 13 with a small clearance between the first lateral face 13a of the tang 13 and the first contact ring 17. Similarly, the frontal face 21d, the frontal face 20c and the contact surface 24a of the second contact ring 18 may be disposed next to the second lateral face 13b of the tang 13, with a small clearance between the second lateral face 13b of the tang 13 and the second contact ring 18.

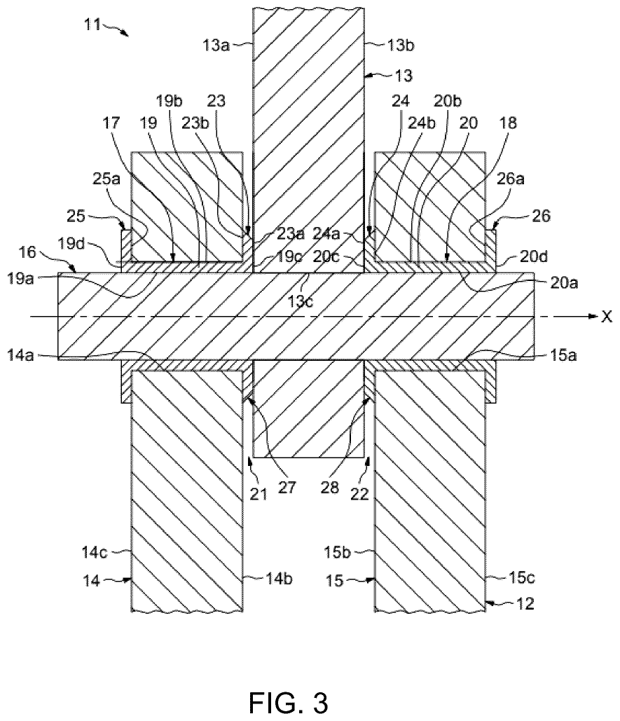

Advantageously, and as is illustrated in FIG. 3, in which elements identical to the embodiment illustrated in FIG. 2 bear the same references, the periphery of the first radial flange 23 of the first contact ring 17 and the periphery of the first radial flange 24 of the second contact ring 18 comprise a bevel 27 and 28, respectively. In one embodiment, the periphery of the second radial flange 25 of the first contact ring 17 and the periphery of the second radial flange 26 of the second contact ring 18 may also comprise a bevel.

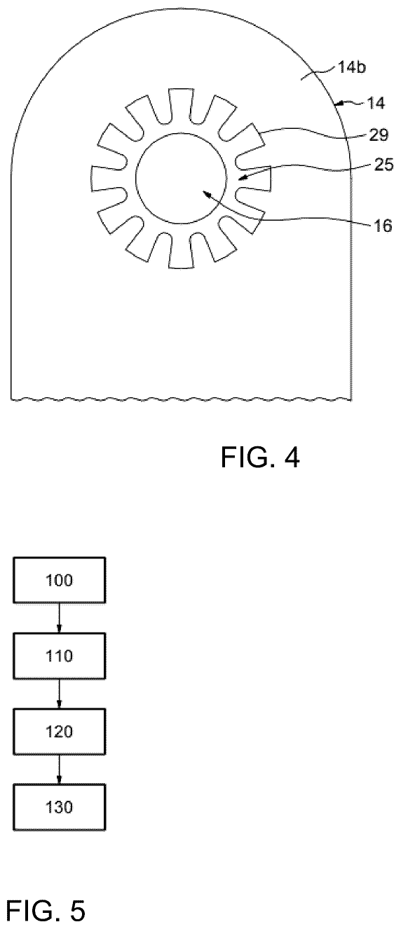

With reference to an embodiment of the mounting assembly 11 that is illustrated in FIG. 4, in which elements identical to the embodiment illustrated in FIG. 2 bear the same references, the second radial flange 25 of the first contact ring 17 has a plurality of radial lips 29 that are spaced apart from one another in the circumferential direction, in this case regularly. Similarly, the second radial flange 26 of the second contact ring 18 has a plurality of radial lips that are spaced apart from one another in the circumferential direction, in this case regularly.

Advantageously, the material of the tang 13 may comprise a metal, for example aluminum or an aluminum alloy. Advantageously, the material of the first and second connecting portions 14 and 15 of the connecting rod 12 may comprise a carbon-fiber-reinforced thermoplastic or thermosetting matrix. The carbon-fiber reinforcements that improve the mechanical properties of the first and second connecting portions 14 and 15 of the connecting rod 12 can be recycled, for example by pyrolysis or vapo-thermolysis, after the mounting assembly 11 has been scrapped, for a future different use. Advantageously, the material of the first and second contact rings 17 and 18 may comprise a plastics material, a fiber-reinforced, such as glass-fiber-reinforced, plastics material, or a metal or an alloy, such as a stainless steel or titanium.

FIG. 5 illustrates a method for manufacturing a mounting assembly 11 according to an embodiment of the disclosure, comprising the first and second connecting portions 14, 15 of the connecting rod 12 and the tang 13, which are assembled around the mounting shaft 16.

The manufacturing method includes a first step 100 of fitting the first contact ring 17 in the bore 14a in the first connecting portion 14 of the connecting rod 12 and fitting the second contact ring 18 in the bore 15a in the second connecting portion 15 of the connecting rod 12. At this stage, the axial portion 19 of the first contact ring 17 fitted on the connecting rod 12 in step 100 has, at a first end, the first radial flange 23. Similarly, the axial portion 20 of the second contact ring 18 fitted on the connecting rod 12 in step 100 has, at a first end, the first radial flange 24. The bearing surfaces 23b and 24b of the first and second contact rings 17, 18 come to bear axially against the first face 14a of the first connecting portion 14 of the connecting rod 12 and the first face 15a of the second connecting portion 15 of the connecting rod 12, respectively.

In a second step 110, the manufacturing method comprises the formation of the second radial flange 25 of the first contact ring 17 and the formation of the second radial flange 26 of the second contact ring 18. The second radial flange 25 of the first contact ring 17 is obtained by deformation of the second end of the axial portion 19, such as riveting.

The first radial flange 23 of the first contact ring 17 may be kept bearing against the first face 14b of the first connecting portion 14 of the connecting rod 12 during the deformation of the axial portion 19, which is compressed against the second face 14c of the first connecting portion 14 of the connecting rod 12, such as by riveting, in order to form the second radial flange 25.

Similarly, the second radial flange 26 of the second contact ring 18 is obtained by deformation of the second end of the axial portion 20.

The first radial flange 24 of the second contact ring 18 may be kept bearing against the first face 15b of the second connecting portion 15 of the connecting rod 12 during the deformation of the axial portion 20, which is compressed against the second face 15c of the second connecting portion 15 of the connecting rod 12, such as by riveting, in order to form the second radial flange 26.

The first and second contact rings 17 and 18 are thus fixed in the bore 14a in the first connecting portion 14 of the connecting rod 12 and in the bore 15a in the second connecting portion 15 of the connecting rod 12, respectively.

This mounting of the first and second contact rings 17 and 18 does not require additional means such as glue. Installation is quick and easy, without requiring, as would be the case for example for fastening by gluing, time for preparing the inner surface of the connecting rod 12 and the outer surface of the mounting rod 16, or time for application, curing, or cleaning.

In a third step 120, the tang 13 is positioned axially between the first and second connecting portions 14, 15 of the connecting rod 12.

The manufacturing method then comprises a fourth step 130 of fitting the tang 13 and the first and second connecting portions 14, 15 of the connecting rod 12, to which the first and second contact rings 17 and 18 are fixed, around the mounting shaft 16 such that the tang 13 is positioned axially between the first and second connecting portions 14, 15 of the connecting rod 12. This can also be described as inserting the mounting shaft 16 through the bores in the first and second connecting portions 14, 15 and the tang 13.

The contact surface 23a of the first radial flange 23 of the first contact ring 17 comes into axial contact with the first lateral face 13a of the tang 13, forming the first axial space 21 between the first connecting portion 14 of the connecting rod 12 and the first face 13a of the tang 13. Furthermore, the contact surface 24a of the first radial flange 24 of the second contact ring 18 comes into axial contact with the second lateral face 13a of the tang 13, forming the second axial space 22 between the second connecting portion 15 of the connecting rod 12 and the second lateral face 13b of the tang 13. The second radial flange 25 of the first contact ring 17 and the second radial flange 26 of the second contact ring 18 may be radially continuous.

Alternatively, the second radial flange 25 of the first contact ring 17 and the second radial flange 26 of the second contact ring 18, which are formed during the method for manufacturing the mounting assembly 11, may have a plurality of radial lips 29. In this case, the second end of the axial portion 19 of the first contact ring 17 and the second end of the axial portion 20 of the second contact ring 18 are radially discontinuous. The deformation of the second end of the radially discontinuous axial portions 19 and 20 results in the plurality of lips 29 being obtained.

Advantageously, the manufacturing method may comprise the formation of a bevel 27 on the periphery of the first radial flange 23 of the first radial ring 17, the bevel being positioned next to the tang 13, and, similarly, of a bevel 28 on the first radial flange 24 of the second contact ring 18.

Alternatively, the manufacturing method may comprise the fitting, in the first step 100, of a first contact ring 17 comprising the second radial flange 25 having a bearing surface 25a bearing against the second face 14c of the first connecting portion 14 of the connecting rod 12, and of a second contact ring 18 comprising the second radial flange 26 having a bearing surface 26a bearing against the second face 15c of the second connecting portion 15 of the connecting rod 12. In the second step 110, the first radial flange 23 of the first contact ring 17, which is intended to come into contact with the tang 13, may then be obtained by deformation of the axial portion 19, and the first radial flange 24 of the second contact ring 18 may be obtained by deformation of the axial portion 20.

According to one example, the first and second connecting portions 14, 15 of the connecting rod 12 that are fitted around the mounting shaft 16 in step 120 may comprise a carbon-fiber-reinforced thermoplastic or thermosetting matrix. According to one example, the tang 13 fitted around the mounting shaft 16 in step 120 may comprise a metallic material, such as aluminum or an aluminum alloy.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved assemblies of connecting rods and tangs and associated methods.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A method for connecting a tang between a first arm and a second arm of a connecting rod, the method comprising:
providing a first contact ring having a cylindrical portion having a first end and a second end and a first flange at the first end of the cylindrical portion of the first contact ring,
inserting the cylindrical portion of the first contact ring into a bore of the first arm until a bearing surface of the first flange of the first contact ring contacts a first side of the first arm or a second side of the first arm,
deforming the second end of the cylindrical portion of the first contact ring to form a second flange at the second end of the cylindrical portion of the first contact ring and to cause a bearing surface of the second flange of the first contact ring to contact the second side of the first arm or the first side of the first arm,
inserting the tang axially between the first arm and the second arm,
inserting a mounting shaft through the bore of the first arm and a bore of the tang and a bore of the second arm, and
positioning the tang and the first arm such that the first flange of the first contact ring or the second flange of the first contact ring contacts or faces a first lateral face of the tang and such that the first arm and the tang are spaced apart by a gap.

2. The method according to claim 1, including:
providing a second contact ring having a cylindrical portion having a first end and a second end and a first flange at the first end of the cylindrical portion of the second contact ring,
inserting the cylindrical portion of the second contact ring into the bore of the second arm until a bearing surface of the first flange of the second contact ring contacts a first side of the second arm, and
deforming the second end of the cylindrical portion of the second contact ring to form a second flange at the second end of the cylindrical portion of the second contact ring and to cause a bearing surface of the second flange of the second contact ring to contact a second side of the second arm.

3. The method according to claim 2,
wherein the second flange of the first contact ring comprises a first plurality of radially extending circumferentially spaced lips, and
wherein the second flange of the second contact ring comprises a second plurality of radially extending circumferentially spaced lips.

4. The method according to claim 2,
wherein an outer surface of the cylindrical portion of the first contact ring contacts an inner cylindrical surface of the bore of the first arm, and
wherein an outer surface of the cylindrical portion of the second contact ring contacts an inner cylindrical surface of the bore of the second arm.

5. The method according to claim 4,
wherein the first lateral face of the tang faces the second side of the first arm and the second lateral face of the tang cases the first side of the second arm.

6. The method according to claim 5,
wherein the first flange of the first contact ring contacts the first side of the first arm and the first flange of the second contact ring contacts the second side of the second arm.

7. The method according to claim 6,
wherein the second flange of the first contact ring contacts the first side of the tang and the second flange of the second contact ring contacts the second side of the tang.

8. The method according to claim 4,
wherein the first flange of the first contact ring contacts the second side of the first arm and the first flange of the second contact ring contacts the first side of the second arm.

9. The method according to claim 8,
including forming a bevel on the first flange of the first contact ring and forming a bevel on the first flange of the second contact ring.

10. A mounting assembly comprising:
a connecting rod having a first arm having a first side, a second side and a bore and a second arm having a first side, a second side and a bore,
a tang having a bore, the tang extending between the first arm and the second arm,
a mounting shaft extending through the bore of the first arm, the bore of the tang and the bore of the second arm, the mounting shaft connecting the tang to the connecting rod, and
a first contact ring having a cylindrical portion extending through the bore of the first arm, a first flange at a first end of the cylindrical portion of the first contact ring having a bearing surface contacting the first side of the first arm, and a second flange at a second end of the cylindrical portion of the first contact ring having a bearing surface contacting the second side of the first arm,
wherein a contact surface of the second flange of the first contact ring faces or contacts a first side of the tang,
wherein the first contact ring is formed as one piece, and
wherein the first arm is spaced from the first side of the tang.

11. The mounting assembly according to claim 10,
including a second contact ring having a cylindrical portion extending through the bore of the second arm, a first flange at a first end of the cylindrical portion of the second contact ring having a bearing surface contacting the second side of the second arm, and a second flange at a second end of the cylindrical portion of the second contact ring having a bearing surface contacting the first side of the second arm,
wherein a contact surface of the second flange of the second contact ring faces or contacts a second side of the tang,
wherein the second contact ring is formed as one piece, and
wherein the second arm is spaced from the second side of the tang.

12. The mounting assembly according to claim 11,
wherein the second flange of the first contact ring comprises a first plurality of radially extending circumferentially spaced lips, and
wherein the second flange of the second contact ring comprises a second plurality of radially extending circumferentially spaced lips.

13. The mounting assembly according to claim 12,
wherein the first and second arms comprise a carbon-fiber-reinforced thermoplastic or thermosetting matrix.

14. The mounting assembly according to claim 13,
wherein the tang comprises aluminum or an aluminum alloy.
